(19) United States
(12) Patent Application Publication
(10) Pub. No.: US 2007/0116910 A1
(43) Pub. Date: May 24, 2007

(54) Multilayer laminated structures

(76) Inventors: Alexander Y. Polykarpov, Williamsville, NY (US); Balasubramaniam Ramalingam, Cary, NC (US)

Correspondence Address: HENKEL CORPORATION, THE TRIAD, SUITE 200, 2200 RENAISSANCE BLVD., GULPH MILLS, PA, 19406, US

(21) Appl. No.: 11/286,507

(22) Filed: Nov. 23, 2005

(51) Int. Cl. B32B 27/32

(52) U.S. Cl. 428/35.2

(57) ABSTRACT

A multilayer laminated structure suitable for use in flexible laminate packaging such as retort pouches contains a sealable layer and an imaging layer. The imaging layer is capable of recording a latent image (by image-wise exposure to actinic radiation, for example) that can be activated to form an image (for example, by operation of an externally applied agent such as pressure and/or heat upon the imaging layer). The sealable layer is utilized to form pouches and other containers from the multilayer laminated structure.

### FIELD OF THE INVENTION

This invention relates to multilayer laminated structures containing imaging layers and the use of such multilayer laminated structures in the manufacture of flexible packaging materials that can be employed to package foodstuffs and other products. The imaging layer allows full color graphics and the like to be incorporated into the packaged product without the use of inks or other conventional printing techniques.

### DISCUSSION OF THE RELATED ART

In recent years, the packaging of various food products in retort pouches has become widespread. Currently used retort pouches are most commonly manufactured by using laminated film structures that have at least three functional layers: a top clear printable film that provides abrasion resistance and structural strength, such as a polyester film; a functional barrier film that provides impermeability against moisture and gases and a cast polypropylene or polyethylene layer that provides a heat-sealable inner surface that can be welded to itself to form an airtight pouch. The layers of the laminate film structure are bonded together using laminating adhesives. The top clear film is typically reverse-printed so that in the laminated structure the printed image ends up protected by the film. Similar laminate films are used as lidding stock for tray containers and the like.

A retort pouch or other retortable container should desirably possess the following properties:
1. It must be heat sealable so that the container can be securely closed following filling;
2. It must be flexible and yet have sufficient toughness, puncture resistance and impact strength to enable the container to withstand expected handling conditions.
3. It must be capable of withstanding sterilization at temperatures in the range of 121 degrees C. to 135 degrees C. to kill botulism and other harmful microorganisms;
4. It must possess non-blocking properties so that the interior opposed faces of the container do not stick together, which would impede filling a pouch or sealing a plastic tray;
5. The laminate film used must be processable without sticking as it is unrolled from the laminate film roll during manufacture of pouches or lidding stock and subsequent sterilization;
6. It must be economical to produce, since such packaging is often intended to contain single use servings and to be discarded after the contents are consumed or used.
7. It must allow the food package to be stored for a prolonged period of time at room temperature without spoiling or degradation of its contents.
8. It must be capable of having images imprinted thereon, both to provide necessary labeling information as well as to provide a means of inducing the consumer to purchase the food package.

In the currently available multi-layered barrier laminates for packaging, the image and product information are printed on the continuous film webs using transfer-type printing technologies. The printing is done on a printing press where the full color image is formed by applying layers of inks using ink-metering devices (typically using gravure cylinders in a gravure method or printing plates in a flexographic method) which can only be set up for one image at a time. Changing to a different image is a costly and time-consuming process. It requires changing of the inks, cylinders or printing plates, and cleaning of the printing equipment, which creates waste.

In principle, inkjet printing could alternatively be used to create images on the flexible laminate films used in food packaging. Although inkjet printing has the advantage of being a digital method, currently available industrial inkjet printers have a number of disadvantages, including insufficient speed for printing high quality images quickly, relatively high equipment costs, and poor adhesion of inkjet-applied inks to untreated or unprimed plastic films.

It would therefore be desirable to develop alternative technology wherein full color images can be generated in the laminate films used in retort pouches and other such food packaging without the use of ink transfer printing processes such as gravure or flexography.

### BRIEF SUMMARY OF THE INVENTION

A color imaging multilayer laminated structure suitable for use in packaging food products is provided by the present invention. The multilayer laminated structure is comprised of an imaging layer (or imaged layer) and a sealable layer. The imaging layer is capable of recording a latent image, wherein the latent image can be activated to form an image (for example, by applying an external activating agent such as pressure and/or heat) to transform the imaging layer into an imaged layer. The multilayer laminated structure may be formed into a flexible laminate packaging material such as a retortable pouch or other type of container. The multilayer laminated structure may include, for example, an outer clear film or protective coating layer; an imaging layer comprising a developer material and a plurality of radiation-sensitive microcapsules encapsulating color precursors; a first adhesive layer; a barrier layer which may be opaque or transparent and which exhibits water vapor and/or oxygen barrier properties; a second adhesive layer; and a sealable layer (preferably, a heat sealable layer). A full color image is obtained when the imaging layer is image-wise exposed with actinic radiation (e.g., visible or UV light) to record a latent image and then, in certain embodiments, subjected to pressure and/or heat development of the latent image either before, during or after the assembly of the layers by lamination. In other embodiments, the image is formed following exposure of the imaging layer to the actinic radiation alone (i.e., the application of an external activating agent is not necessary). A pouch may be formed by sealing the edges of two sections of the multilayer laminated structure so that the sealable sides of each section face inward and are sealed together by heat or by use of an adhesive.

The multilayer laminated structure provided in one embodiment of the present invention already contains an image-forming (image-recording) means and can create a desired image in one step without the use of inks, printing plates or expensive gravure cylinders. The imaging layer typically is applied as a single uniform layer, thereby avoiding the need to selectively apply imaging chemicals to a film or other substrate as must be done using conventional printing techniques. Thus, there is no need for cleaning a printing station and no waste is generated. Furthermore, the image can be changed at any time simply by changing the image-wise exposure settings on the printer. It also becomes possible to print different images on the same web in a single pass. In addition, the present invention is readily adaptable to commercial, high speed production, since the image-wise exposure of the imaging layer takes only milliseconds and further development of the image can be done in coordination with the lamination steps involved in assembling the finished laminate, which can be carried out at very high speeds. Additionally, the imaging device used to expose the imaging layer can utilize a relatively simple and inexpensive optical system that does not contact the multilayer laminated structure, unlike the complex mechanical devices that must be used as printing heads in inkjet printing.

### BRIEF DESCRIPTION OF THE DRAWINGS

FIG. 1 is a cross-sectional view (not to scale) of one embodiment of a multilayer laminated structure in accordance with the invention.

FIG. 2 is a cross-sectional view (not to scale) of the multilayer laminated structure of FIG. 1 after exposing the structure to actinic radiation in an image-wise manner and rupturing certain of the microcapsules.

FIG. 3 is a cross-sectional view (not to scale) of a portion of one embodiment of a sealed packaging material in accordance with the invention wherein two portions of a multilayer laminated structure have been sealed in each other in a certain region and the imaging layer has been exposed and developed.

FIG. 4 illustrates in schematic form one way in which a multilayer laminated structure in accordance with the present invention can be assembled, image-wise exposed, and-developed to form an image within the structure.

### DETAILED DESCRIPTION OF CERTAIN EMBODIMENTS OF THE INVENTION

The multilayer laminated structures of the present invention are, in preferred embodiments, relatively thin and flexible laminate materials. Preferably, for example, the multilayer laminated structure is not more than about 500 microns thick (alternatively, not more than about 400 or about 300 microns thick) and is capable of being readily folded upon itself without cracking or tearing (both at room temperature and at lower temperatures, e.g., −20 degrees C.).

The multilayer laminated structures can be used as laminate packaging materials for use with foodstuffs as well as other non-food products. In particular, the multilayer laminated structures can be formed into retortable pouches by heat sealing the edges of one or more sheets of the multilayer laminated structure such that the sealable layers face inward and are welded or bonded together. The pouch and a foodstuff packaged therein can, in certain embodiments, be pasteurized (sterilized) by heating, wherein both the multilayer laminated structure sheets and the heat seals maintain their integrity (e.g., do not degrade or undergo delamination or separation of the welded heat sealable layers). However, the multilayer laminated structures of the present invention are also suitable for use in other packaging applications such as non-retort food containers as well as packaging for products other than foodstuffs.

The imaging layer utilized in the present invention may be any system capable of recording a latent image that can be activated to form an image by operation of an externally applied agent upon the imaging layer or by self-activation (e.g., through the use of a masked or latent activating agent within the imaging layer that is activated by the means used to record the latent image). That is, the imaging layer provides a method of forming an image in the multilayer laminated structure after the multilayer laminated structure is assembled, thereby-avoiding the need to apply an inked image to a layer of a laminate prior to assembly of the laminate. Alternatively, the latent image can be developed in coordination with lamination of the layers of the multilayer laminated structure. Where the multilayer laminated structure is to be fabricated into a retortable food pouch, the imaging layer and the other layers of the structure should be selected such that the migration of undesired or potentially harmful substances from the imaging layer through the structure into the contents of the pouch is minimized or at least meets the applicable requirements that may be imposed by regulation. For example, the chemistry of the imaging layer may be adjusted so as to eliminate the presence of such substances once the food pouch is fabricated and filled or a barrier layer may be interposed between the imaging layer and the pouch contents so as to block such substances from reaching the packaged foodstuff.

Various image forming technologies can be used in the present invention. The image can be created using actinic radiation-, heat- or pressure-sensitive systems or a combination thereof. The external activating agent thus may be, for example, heat, actinic radiation (e.g., visible light, ultraviolet light, infrared radiation, electron beam radiation, gamma radiation, x-rays), pressure or some combination thereof. The imaging layer may comprise two or more different layers that together cooperate or interact so as to provide the capability of creating a latent image that can be activated by one or more externally applied agents. However, the single layer full color imaging technologies (where the image forming chemicals can be applied as a single layer) are preferred for use in this invention.

Many different methods of converting dye precursors into dyes are known in the art and can be adapted for use in the imaging layers of the present invention. Such methods include, but are not limited to, reaction with acid or base, oxidation, heat, light or other radiation, or the like. For example, various approaches for turning leuco dyes into their colored form are described in R. Muthyala, Chemistry and Applications of Leuco Dyes, New York, Plenum Press, 1997.

In one especially suitable embodiment of the invention, the imaging layer comprises radiation-hardenable microcapsules encapsulating a coloring material (also sometimes referred to as a color precursor or dye precursor or color former) and, outside the microcapsules, a developer material. A binder or adhesive may also be present in the imaging layer. The imaging layer may be colored, for example, by pressure development after being exposed to radiation based on image information (e.g., the intensity and/or wavelength of the radiation is varied across the imaging layer so as to expose different regions of the imaging layer to differing amounts or types of radiation). The microcapsules exposed to radiation are differentially cured or hardened such that the radiation-hardenable composition used to encapsulate the microcapsules is increased in viscosity or mechanical strength (e.g., by an increased extent of crosslinking and/or chain extension), thereby immobilizing the coloring material proportionately to the desired tonal depth in the area exposed to the radiation. The microcapsules are ruptured by application of pressure to the imaging layer, whereupon the coloring material contained within the microcapsules flows out of the microcapsules and/or the developer material previously excluded from the microcapsules is able to migrate into the microcapsules (in amounts varying with the degree to which the microcapsules have been hardened or cured by exposure to the radiation). The coloring material originally contained within the microcapsules may then come into contact with the developer material, causing the two materials to react and transforming the coloring material (which originally was substantially colorless) into a colored material (e.g., a dye).

Although the thickness of the imaging layer is not believed to be critical and may vary depending the particular imaging system selected, typically the imaging layer is present in the multilayer laminated structure at a dry coating weight of from about 1 to about 100 g/m². The components and thickness of the imaging layer preferably are chosen so that the multilayer laminated structure remains flexible, both before and after activation of the imaging layer to form an image, and the structure is resistant to delamination (separation of the individual layers).

The following imaging technologies that are based on microencapsulation of the color forming agents can be utilized, among others:

The transfer imaging system described in U.S. Pat. Nos. 4,399,209 and 4,440,846 (each of these being incorporated herein by reference in its entirety) may be adapted for use as the imaging layer. In such a system, images are. formed by image-wise reaction of one or more chromogenic materials and one or more developers. The system may comprise an imaging sheet comprising a first substrate, a chromogenic material, a radiation-curable composition which undergoes an increase in viscosity upon exposure to actinic radiation and which is encapsulated in rupturable capsules as an internal phase, a coating on one surface of the first substrate that comprises the chromogenic material and the radiation-curable composition, and a developer sheet comprised of a second substrate and a developer material capable of reacting with the chromogenic material to form an image on one side of the second substrate. Alternatively, the system may comprise a substrate having front and back surfaces, a chromogenic material, a radiation-curable composition which undergoes an increase in viscosity upon exposure to actinic radiation and which is encapsulated in rupturable capsules as an internal phase, a coating containing the chromogenic material and the radiation-curable composition on at least one surface of the substrate, and a developer material capable of reacting with the chromogenic material to form a visible image. Images are formed by image-wise exposing the coating to actinic radiation and rupturing the capsules in the image areas, thereby image-wise releasing the internal phase from the ruptured capsules in the image areas. A patterned image-forming reaction takes place between the chromogenic material and the developer material. Heating the substrate having the microcapsules containing the radiation curable composition coated thereon before or after the image-wise exposing step may provide certain benefits, as described in U.S. Pat. Nos. 4,873,168 and 6,638,678 (each incorporated herein by reference in its entirety).

Methods for producing microcapsules useful in the aforementioned imaging systems as well as other systems employing encapsulated photosensitive imaging materials are described, for example, in U.S. Pat. Nos. 4,962,010 and 5,283,015 (each of which is incorporated herein by reference in its entirety). The capsules may contain a photohardenable or photosoftenable material as the radiation sensitive material. For example, the capsules may contain a polyethylenically unsaturated monomer, a photoinitiator, and a dye precursor. The walls of the microcapsules may be formed from a condensation product of amine and formaldehyde or a condensation product of polyisocyanate and an active hydrogen compound such as a polyol, water, or polyamine or a mixture of such condensation products. Suitable materials for forming microcapsule walls are described, for example, in U.S. Pat. Nos. 6,964,836; 3,796,669; 4,001,140; 4,087,376; and 4,089,802 (each of which is incorporated herein by reference in its entirety). Another process for forming photosensitive microcapsules suitable for use in the imaging layer of the present invention is described in United States Published Patent Application No. 2003/0175612 (incorporated herein by reference in its entirety). Such process comprises the steps of forming an emulsion of an oily core material in a continuous aqueous phase containing a carboxyvinyl polymer and enwrapping particles of the oily core material in an amine-formaldehyde (e.g., melamine-formaldehyde) or amide-formaldehyde (e.g., urea-formaldehyde) condensation product.

The microcapsule walls may be formulated so as to provide better adhesion of the microcapsules in the imaging layer to adjacent layers within the multilayer laminated structures of the present invention. For example, where the imaging layer is to be coated onto a metallic substrate, such as a metallic foil or a metallized polymer film, the outer surface of the microcapsules may be modified to include a coupling agent such as a silane, titanate or zirconate, as described in U.S. Pat. No. 4,971,885 (incorporated herein by reference in its entirety). Modification of the microcapsule walls to include adhesion promoters, compatibilizing agents, coupling agents and the like may also be advantageous where it is desired to have the imaging layer to also function as an adhesive layer to bond layers of the multilayer laminated structure together (i.e., to prevent delamination). For example, the exterior surfaces of the microcapsules may be coated with a substance that helps to improve the bond strength of the imaging layer/adhesive layer once the adhesive matrix is cured.

Further improvements to the imaging system of U.S. Pat. No. 4,440,846 are described in U.S. Pat. No. 4,766,050 (incorporated herein by reference in its entirety) and may also be adapted for use in the imaging layer component of the present invention. The improved imaging system comprises a layer containing opacifying agent, a layer containing microcapsules (the microcapsules containing a color former and a photohardenable or photosoftenable photosensitive composition), and a layer of developer material. These layers are positioned such that upon rupturing the microcapsules, the color former diffuses to the developer material layer to form an image in the developer material layer. The image is viewed against the layer containing opacifying agent, which shields the microcapsules from the image.

A related imaging system which is described in U.S. Pat. No. 4,416,966 (incorporated herein by reference in its entirety) or a variation thereof may also be used as the imaging layer in the present invention. This system may comprise, for example, an imaging sheet and a background dye or a combination of a dye precursor and a dye developer which react to form a background dye. The imaging sheet may include a support and a plurality of capsules in a layer on one surface of the support, wherein the capsules contain an internal phase comprising a decolorizing agent and a photohardenable or photosoftenable radiation-sensitive composition. Images can be formed by image-wise exposing the imaging sheet to actinic radiation and rupturing the capsules so that the decolorizing agent is released from the capsules and reacts with the associated background dye to decolorize it or inhibits, prevents or reverses the color-forming reaction of the dye precursor and dye developer to produce a color difference in the form of an image.

U.S. Pat. No. 4,772,530 (incorporated herein by reference in its entirety) describes visible light sensitive photohardenable compositions which are also useful in the imaging systems described in the aforementioned U.S. Pat. Nos. 4,399,209 and 4,440,846.

Other photosensitive compositions useful in the imaging systems of U.S. Pat. Nos. 4,399,209, 4,440,846, and 4,772,530 and thus also suitable for use in the imaging layer component of the present invention are described in U.S. Pat. No. 6,174,642 (incorporated herein by reference in its entirety). Such compositions comprise a photoinitiator which is a complex between an infra-red sensitive dye and a boranyl anion such as triphenylbutylboranyl anion. The imaging system may include different sets of microcapsules, such as microcapsules containing a cyan color-forming agent, microcapsules containing a magenta color-forming agent, as well as microcapsules containing a yellow color-forming agent. The imaging layer is exposed to three distinct wavelengths of actinic radiation which each selectively harden just one set of microcapsules, with the microcapsules thereafter subjected to a rupturing force.

An adhesion promoter may additionally be present in the imaging layer component of the present invention, such as, for example, the adhesion promoters described in U.S. Pat. No. 6,387,585 (incorporated herein by reference in its entirety). The imaging layer thus may be comprised of a plurality of photosensitive microcapsules, a developer material, and an adhesion promoter, wherein the adhesion promoter helps to improve the peel strength as well as temperature and humidity performance of a laminate formed using the imaging layer

Still another related imaging system useful in the imaging layer of the present invention is described in U.S. Pat. No. 4,842,976 (incorporated herein by reference in its entirety). In this system, images are formed by reaction of a color precursor and a developer, wherein the reaction of the color precursor and developer is controlled by exposure of a photosensitive composition encapsulated in pressure rupturable capsules. For example, cyan, magenta and yellow precursors are carried on separate imaging sheets in combination with an encapsulated photosensitive composition and images are formed by image-wise transferring the precursors to an image-receiving developer sheet.

The imaging layer may, in another embodiment, comprise a developer material (e.g., a phenolic resin) and photohardenable microcapsules encapsulating a photohardenable composition containing a color precursor (such as a leuco dye), a polyethylenically unsaturated compound, a cyaninelborate photoinitiator, and a disulfide. The microcapsules may be formed of melamine-formaldehyde or urea-formaldehyde. The color is formed when the microcapsules are ruptured by pressure, thereby releasing the dye precursors to react with the developer compounds outside the microcapsules. Reaction with the developer compounds causes the dye precursors to turn into their colored forms. Descriptions of this type of imaging layer may found in U.S. Pat. Nos. 5,783,353 and 5,916,727, each of which is incorporated herein by reference in its entirety.

In another embodiment, the imaging layer is comprised of microcapsules containing dye precursors (such as achromic or hypochromic electron-donating dye precursors) and developers (also sometimes referred to as dye couplers or dye-forming chemicals) outside. Image-wise heating of the microcapsules renders their walls permeable to the developers, which diffuse through the microcapsule wall and react with the substances contained within the microcapsules, forming colored dyes. Such a process (sometimes referred to as a-thermoautochrome system) is described, for example, in U.S. Pat. No. 6,890,880, incorporated herein by reference in its entirety.

Alternatively, the imaging layer employed in the present invention may be based upon the photopolymerizable compositions described in U.S. Pat. No. 6,756,177 (incorporated herein by reference in its entirety). These compositions comprise a polymerizable compound having an ethylenically unsaturated bond, a pyrimidine-type compound, and a radical generating agent (such as an organic boron compound) capable of generating a radical by interacting with the pyrimidine-type compound. Microencapsulation techniques, wherein a color forming component is contained within thermally responsive microcapsules and is made available for reaction with another color forming component by heating the imaging layer containing the microcapsules after exposing the imaging layer to light radiation, are also described in this patent.

Another suitable system, described in U.S. Pat. No. 6,740,465 (incorporated herein by reference in its entirety), contains an imaging layer comprising photohardenable microcapsules containing a photopolymerizable or photocrosslinkable compound, a photoinitiator and a dye precursor as well as a finely divided particulate developer material external to the microcapsules. Image-wise exposure of the imaging layer to actinic radiation causes selective photohardening of microcapsules sensitive to such radiation. Heating the irradiated imaging layer to a temperature above the melting point of the developer material (using a thermal head, for example), permits the developer material to selectively permeate the non-photohardened microcapsules, leading to the development of an image. The image can be a full color image, which may be obtained by the use of multiple kinds of microcapsules (for example, a first containing a cyan dye precursor, a second containing a magenta dye precursor, and a third containing a yellow dye precursor).

In still another embodiment, a magnetophoretic and electromagnetophoretic imaging layer comprising microcells or microcapsules containing magnetic particles can be utilized. This type of imaging layer is described, for example, in U.S. Pat. No. 6,927,892 (incorporated herein by reference in its entirety).

An imaging layer comprising leucobase and leuconitrile color formers that is imaged by exposure to actinic radiation is also suitable for use in the multilayer laminated structures of the present invention. U.S. Pat. No. 6,309,797 (incorporated herein by reference in its entirety) provides further details regarding this type of imaging layer. The imaging layer additionally is comprised of an oxidizing agent. A first color former which yields a first dye cation upon exposure to the actinic radiation in the presence of the oxidizing agent as well as a second color former which yields a second dye cation and a leaving group by heterolysis may be present, wherein the first dye cation is bleached by further radiation in the presence of the second color former.

In yet another embodiment of the invention, the imaging layer contains microcapsules having acid or base sensitive walls, such as the acid-triggered microcapsules described in U.S. Pat. No. 6,514,439 (incorporated herein by reference in its entirety). The microcapsules thus may be formed of a polyurea shell wall comprising at least one oligomeric acetal which encapsulates a color precursor, with the imaging layer additionally containing a color developer outside of the microcapsules. When an acid is introduced, the microcapsule wall is relatively readily degraded or disintegrated by the acid, thereby releasing the encapsulated color precursor and allowing it to react with the color developer. The acid may be introduced by co-encapsulating a masked acid such as a cationic photoinitiator with the other contents of the microcapsule.

When the imaging layer is image-wise exposed to actinic radiation such as ultraviolet light, the masked photoinitiator within the individual microcapsules that are irradiated is activated and becomes available for reaction with the acid-sensitive microcapsule walls. The photoinitiator in the microcapsules that are not exposed to the radiation is not activated, so these microcapsules remain intact and the color precursor is not released for reaction with the color developer.

A similar color precursor release mechanism can also be used in place of or as a supplement to the color precursor release mechanisms involving pressure and/or heat mentioned elsewhere in this application. For example, the microcapsule walls may be constructed of a material having acid resistance that can be altered by exposing the microcapsules to a particular wavelength of radiation (for example, the microcapsules can be rendered more or less resistant to attack by acid when exposed to such radiation). In addition to such microcapsules (containing color precursors), the imaging layer also contains a masked or latent photoinitiator capable of being activated using radiation of a different wavelength. To form the image, the imaging layer is first image-wise exposed to the radiation wavelength that selectively modifies the acid resistance of the microcapsules and then exposed (in a uniform manner) to the different radiation wavelength that activates the photoinitiator also present in the imaging layer. The activated photoinitiator (acid) then reacts with the walls of the microcapsules which are acid-sensitive, allowing the color precursor within such microcapsules to react with the color developer present in the imaging layer. In this embodiment of the invention, the radiation which is uniformly applied to the imaging layer to trigger the masked photoinitiator may be considered the externally applied activating agent.

Still another variation of the present invention utilizes an imaging layer comprising microcapsules that contain a color precursor, wherein the walls of the microcapsules initially shield the color precursor from contact with a color developer in the imaging layer matrix outside of the microcapsule walls and are comprised of a material such as a polymer. The microcapsule walls are rendered disintegrable by adding an infrared absorber such as an IR absorbing dye (preferably transparent in the visible spectrum) to the microcapsule wall material and/or the encapsulated material. The imaging layer in the multilayer laminated structure is image-wise exposed to infrared radiation, whereby the. infrared absorber in the microcapsules within the irradiated regions of the imaging layer causes the walls of the microcapsules exposed to the infrared radiation to disintegrate (typically, due to melting of the wall material and/or an increase in pressure within the microcapsule). This permits the encapsulated color precursor to come into contact with and react with the color developer. In this embodiment of the invention, the imaging layer may be considered to be self-activating. That is, the latent image created in the imaging layer by exposure to actinic radiation develops into an image without the need to apply an external activating agent such as pressure or heat. Infrared-releasable microcapsules that can be adapted for use in the imaging layers of the present invention are described, for example, in U.S. Pat. No. 6,936,644 (incorporated herein by reference in its entirety).

Also useful in the present invention is a silver-based radiation-hardenable microencapsulated imaging system such as those described in U.S. Pat. Nos. 4,912,011, 5,091,280, and 5,118,590, as well as other patents assigned to Fuji Photo Film Co. (all the foregoing patents being incorporated herein by reference in their entirety).

To record images in the imaging layer component of the multilayer laminated structures of the present invention (i.e., to create a latent image within the imaging layer), any suitable method may be utilized. Such method may be selected based upon the particular chemistry and image creation mechanism of the particular imaging layer that is used. For example, where the imaging layer comprises photosensitive microcapsules and developer material (as in U.S. Pat. Nos. 5,783,353 and 5,916,727), the imaging layer may be imaged (i.e., a latent image can be recorded) using a printer which incorporates an LED/developer head of the type described in U.S. Pat. No. 5,550,627 (incorporated herein by reference in its entirety). Image forming devices (also sometimes referred to as printers) which can be adapted for use with the multilayer laminated structures of the present invention are also described, for example, in U.S. Pat. Nos. 4,740,809, 4,992,822, 5,893,662 and 4,648,699, each of which is incorporated herein by reference in its entirety.

Systems and methods that can be utilized to form a latent image within an imaging layer in accordance with the present invention that contains microcapsules encapsulating a color-forming material, wherein the microcapsules undergo a change in mechanical strength upon exposure to light having a certain wavelength, are described in U.S. Pat. Nos. 4,941,038 and 6,077,810 (each incorporated herein by reference in its entirety). For example, a latent image recording system may comprise an irradiation unit that selectively emits the light having the desired wavelength to the imaging layer, a pressure-development unit that ruptures the microcapsules with pressure based on the latent image so that the encapsulated color-forming material flows out so as to form an image, and a heating unit that heats the imaging layer (for example, using a plurality of heating steps) to promote the color-forming reaction.

The aforementioned imaging technologies can be modified for use in this invention such as by using different microencapsulation techniques and a combination of imaging processes. Imaging methods that are not based on encapsulation can also be used in this invention. For example, an imaging process that is based on reaction of leuco dyes with photogenerated acids and acids generated in the secondary processes is described in U.S. Pat. No. 6,307,085 and references cited therein (each of which being incorporated herein by reference in its entirety). Even though the aforementioned U.S. Pat. No. 6,307,085 describes a multilayered imaging structure, the same chemistry could be readily adapted for use as a single layer wherein a certain reactant or combination of reactants is kept separated from the other reactant(s) by encapsulation in the form of microcapsules.

To be suitable for use as part of a flexible laminate packaging material, the multilayer laminated structure of the present invention preferably contains at least one barrier layer. The barrier layer may be comprised of any material that is substantially impervious to gas, i.e., a material that provides impermeability to gases, in particular oxygen and water vapor. The function of the barrier layer is to prevent or at least significantly retard the passage of oxygen and other gases through the multilayer laminated structures of the present invention that would otherwise degrade or spoil the contents of the package formed from such multilayer laminated structures. Barrier materials are well-known in the laminate packaging art and may be, for example, metallic foils, polymeric films coated with one or more inorganic oxides, metallized polymeric films, metallic foils laminated or adhered to polymeric films, polymeric films that inherently provide low gas transmission rates, and the like. The barrier layer may be clear, opaque or translucent.

In certain embodiments of the invention, the barrier layer selected has an oxygen transmission rate of no more than 5 cm³/m² (alternatively, no more than 3 cm³/m², alternatively, no more than 1 cm³/m²) per day at 25 degrees C., 0% relative humidity (RH) and/or a moisture vapor transmission rate of no more than 4 cm³/m² (alternatively, no more than 2 cm³/m², alternatively, no more than 1 cm³/m²) per day at 40 degrees C, 100% RH.

Polymers that can be used in such polymeric films include, but are not limited to, polyethylene (including low density polyethylene (LDPE), medium density polyethylene (MDPE), high density polyethylene (HPDE), high molecular weight, high density polyethylene (HMW-HDPE), linear low density polyethylene (LLDPE), linear medium density polyethylene (LMDPE)), polypropylene (PP), oriented polypropylene, polyesters such as poly(ethylene terephthalate) (PET) and poly(butylene terephthalate) (PBT), ethylene-vinyl acetate copolymers (EVA), ethylene-vinyl alcohol copolymers (EVOH), ethylene-acrylic acid copolymers (EAA), ethylene-methyl methacrylate copolymers (EMA), ethylene-methacrylic acid salts (ionomers), polyamides (nylon), polyvinyl chloride (PVC), poly(vinylidene chloride) copolymers (PVDC), polybutylene, ethylene-propylene copolymers, polycarbonates (PC), polystyrene (PS), styrene copolymers, high impact polystyrene (HIPS), acrylonitrile-butadiene-styrene polymers (ABS), and acrylonitrile copolymers (AN).

A film of such a polymer may be metallized by depositing a thin layer of a metal such as aluminum, gold, silver, platinum, palladium, tin, nickel, cobalt, nickel, zinc, titanium, indium or mixtures thereof onto the film's surface. Inorganic oxides such as AlOₓ (aluminum oxides), SiOₓ (silicon oxides), ZnOₓ (zinc oxides), TiOₓ (titanium oxides) as well as mixed metal oxides or mixed metal-Si oxides may also be vapor deposited onto the surface of the polymeric film using methods well known in the art. The vapor deposited film can be provided on at least one side of the polymeric film by a vacuum vapor deposition method (physical vapor phase growth methods, chemical vapor phase growth methods, etc.), ion plating method, sputtering method, reaction vapor deposition method, electrode beam vaporization or the like. The vapor-deposited treatment layers can be obtained by vapor deposition techniques well known to those skilled in the art, and such techniques include physical vapor deposition (PVD) which includes thermal evaporation, electron beam deposition, inductive and/or resistive deposition, ion plating, sputtering, plasma-activated evaporation, reactive evaporation, and activated reactive evaporation; and chemical vapor deposition (CVD). Physical vapor deposition also has been referred to in the literature as vacuum metallization and evaporative coating. In thermal evaporation deposition procedures, the material to be applied to the film surface (generally a metal or alloy) is heated in a high vacuum whereupon the material evaporates or sublimates and travels to the film to be coated. In sputtering processes, energetic inert ions created in a plasma discharge impact a target and cause the ejection of coating material through momentum exchange. Physical vapor deposition essentially involves the transfer of the material and the formation of coatings by physical means alone in contrast to chemical vapor deposition in which the material transfer is effected by chemical reactions induced by temperature or concentration gradients between the substrate and the surrounding gaseous atmosphere. Chemical vapor deposition usually is accomplished by vaporizing a metallic halide and decomposing or reacting the vapors at the film surface to yield the non-volatile metal on the surface of the film as a coating. The chemical reactions of vapor deposition can be effected by thermal deposition or pyrolysis, hydrogen reduction, reduction with metal vapors, chemical transport reactions, etc. The thickness of the deposited coating of inorganic oxide or metal may be, for example, 10 to 500 nm, 20 to 200 nm, or 30 to 100 nm.

The ceramic barrier layers described in U.S. Pat. No. 6,544,711 (incorporated herein by reference in its entirety) may also be adapted for use in the multilayer laminated structures of the present invention.

A barrier layer may alternatively be created in the multilayer laminated structures of the present invention through the use of other substances capable of retarding the migration of gases and other volatile materials through the multilayer laminated structure. Such other substances need not be comprised of a polymeric film. For example, a barrier layer may be provided by a layer comprising a mixture of an adhesive and surface-modified exfoliated montmorillonite clay platelets, as described in U.S. Pat. No. 6,846,532 (incorporated herein by reference in its entirety), or a mixture of an adhesive and fillers having a platelet-like crystallite structure with an aspect ratio of >100 (as described in U.S. Pat. Pub. No. 2005-0228096, incorporated herein by reference in its entirety).

A removable barrier layer, particularly a removable barrier layer having a low water vapor transmission rate, may be used to temporarily protect the multilayer laminated structure, in particular to temporarily protect the imaging layer before development of the recorded image. The barrier layer can be removed after the image is developed. A removable barrier layer may be placed on one or both sides of the multilayer laminated structure; it may be especially desirable to have a removable barrier layer on any side of the multilayer laminated structure that does not already have a barrier layer having a low water vapor transmission rate in the multilayer laminated structure between the imaging layer and the outside surface of the structure. The removably adherent barrier sheet materials and methods for utilizing such sheet materials in self-contained photohardenable imaging assemblies that are described in U.S. Pat. No. 6,537,717 (incorporated herein by reference in its entirety) may be readily adapted for use together with the multilayer laminated structures of the present invention. If the imaging layer is to be image-wise exposed using actinic radiation and a removable barrier layer is placed on the side of the multilayer laminated structure that is to be exposed to the actinic radiation, then it will be preferred to select a removable barrier layer that is transparent to the actinic radiation that is used. The removable barrier layer can be attached to the multilayer laminated structure using any suitable means, such as, for example, a peelable adhesive.

The adhesive layer(s) may be comprised of any material that is capable of adhering different layers of the multilayer laminated structure of the present invention to each other, preferably providing sufficient lamination bond strength and peel strength to prevent such adhered layers from separating or delaminating during normal use and handling (including, for example, retorting of the filled package produced from the multilayer laminated structure). Any of the known laminating adhesives may be utilized for such purpose, including solvent-borne adhesives, water-borne adhesives, solvent-free adhesives, one part adhesives, two part adhesives, radiation-curable adhesives, thermosettable adhesives, hot melt adhesives, pressure sensitive adhesives and the like. The adhesive used may be a dual cure system, such as, for example, an adhesive that cures by both hardener-induced crosslinking and/or chain extension and radiation-induced crosslinking and/or chain extension. In one embodiment of the invention, the adhesive layer is formed by combining and curing a two part solventless polyurethane adhesive, wherein one part comprises an isocyanate-functionalized polyurethane prepolymer and the second part comprises at least one active hydrogen-containing hardener such as a polyester polyol that is capable of curing the polyurethane prepolymer. As described in more detail below, in one embodiment of the invention an adhesive layer and an imaging layer are combined (that is, the combined adhesive layer/imaging layer functions to adhere or bond adjacent layers of the multilayer laminated structure together so as to prevent delamination during subsequent processing of the structure, such as retorting a pouch fabricated from the multilayer laminated structure, and also to provide the capability of recording a latent image that can be developed into an image by activation with an externally applied agent, for example). In this embodiment, the adhesive components are selected such that they do not interfere with the ability of the imaging components to form an activatable latent image. The adhesive components thus, for example, should not interfere with the development of a full color image nor degrade the long term stability of the developed image.

The multilayer laminate structures of the present invention include a layer that is capable of being sealed to itself or to another layer, with suitable sealing means including heat sealing and well as adhesive sealing.

As used herein, the term “heat-seal” or the like terminology refers to the union of at least two films by bringing the films into contact, or at least close proximity, with one another and then applying sufficient heat and pressure to a predetermined area (or areas) of the films to cause the contacting surfaces of the films in the predetermined area to become molten and intermix with one another, thereby forming an essentially inseparable bond between the two films in the predetermined area(s) when the heat and pressure are removed therefrom and the area is allowed to cool. The heat sealable layer utilized in the multilayer laminated structures of the present invention may be comprised of any material that is capable of being welded to itself or another heat sealable layer to form an air- and water-tight package. Such material thus should have a softening temperature low enough to be sealed without damaging the contents of the package formed from the multilayer laminated structure containing the heat sealable layer, but high enough for the seal formed by the heat sealable layer to survive any subsequent desired handling or treatment of the sealed package such as retorting.

Such materials are well-known in the laminate packaging art and are generally thermoplastics, including, for example, polyolefins such as polyethylene (e.g., cast polyethylene, high density polyethylene, medium density polyethylene and low density polyethylene), polypropylene (e.g., cast polypropylene), ethylene/alpha-olefin copolymers, propylene/ethylene copolymers, and ethylene/vinyl acetate copolymers, polyamides, polyesters, polyvinyl chlorides, ionomers, (meth)acrylate polymers such as ethylene/(meth)acrylic acid copolymers, ethylene/acrylic acid copolymers, ethylene/n-butyl acrylate copolymers and the like and blends thereof. The heat sealable layer may further one or more additives such as antiblocking agents, fillers, colorants, stabilizers, antioxidants, plasticizers, processing agents, or antifog agents, or may be devoid of such agents. The heat sealable layer is generally in the form of a thin, flexible sheet or film, with a thickness typically in the range of from about 5 to about 120 microns. Coextruded films may be used as the heat sealable layer, such as, for example, a coextruded film of an ethylene/vinyl acetate copolymer and high density polyethylene. The thickness of the heat sealable layer is selected to provide sufficient material to attain a strong bond when sealed, but should not be so thick so as to interfere with the manufacture (e.g., extrusion) of the heat sealable layer by lowering the melt strength or flexibility of the layer to an unacceptable level.

The components of the heat sealable layer preferably are selected so that the softening point of the layer is lower than that of the other layers of the multilayer laminated structure (once any curable layers such as a thermosettable adhesive layer is cured). At the same time, however, when the multilayer laminated structure is to be formed into a pouch that is retorted, the softening point of the heat sealable layer preferably should be sufficiently high such that the portions of the heat sealable layer that are heat-sealed resist delamination or separation during the retort heating process. For example, the heat sealable layer may have a Vicat softening temperature of at least 100 degrees C., 110 degrees C., or 120 degrees C. Preferably, the Vicat softening temperature of the heat sealable layer is not greater than about 150 degrees C. or about 140 degrees C. The Vicat softening temperature may be measured according to ASTM 1525/ISO 306 (1 kg), which is incorporated herein by reference in its entirety.

Where sealing is to be accomplished by means other than heat sealing, then the sealable layer may also be formed of materials other than those capable of being heat sealed. For example, where sealing of the multilayer laminate structure is carried out using an adhesive, then the sealable layer may be comprised of a thermoset polymer film, a thermoplastic polymer film (including thermoplastic polymer films having a softening temperature too high to allow heat sealing), a metallic foil, paper (including coated paper), or the like. The sealable layer and the adhesive employed should be selected so as to be compatible with each other. For example, the adhesive should normally provide a strong bond between the sealable layer and the substrate to which the sealable layer is to be sealed. Illustrative suitable adhesives include any of the adhesive systems described elsewhere in this application, such as, for example, cold seal adhesives, pressure sensitive adhesives, resealable adhesives and the like. The sealable layer can be pretreated with a primer, oxidizing agent, flame or the like to improve adhesion, if needed. Additionally, where the sealable layer will be on the interior side of a pouch used for food packaging, the sealable layer should be chosen so that the foodstuff is not spoiled or contaminated by substances in the sealable layer or migrating through the sealable layer.

In one embodiment of the invention, the sealable layer also has barrier properties. That is, the components of the layer are selected so that it is capable of being sealed to another substrate and also substantially blocks or inhibits the transmission of gases such as oxygen and water vapor. Certain of the barrier layers discussed previously thus may also be utilized as a sealable layer.

The multilayer laminated structures of the present invention may additionally be comprised of one or more clear films, e.g., a transparent, thin, flexible sheet comprised of a polymer. The clear film preferably is non-yellowing and otherwise stable over long periods of time under the conditions that the finished product fabricated from the multilayer laminated structure is expected to encounter (e.g., retorting, exposure to light). The polymer may be a thermoplastic, including any of the polymers mentioned previously herein in connection with the barrier layer. If the clear film is on the outside of the package formed from the multilayer laminated structure, it will generally be desirable for the clear film to be comprised of an abrasion-resistant polymer, particularly a polyester such as polyethylene terephthalate. Other suitable polymers include, but are not limited to, polyamides (e.g., nylon) and polyolefins (e.g., polyethylene, polypropylene). The thickness of the clear film may be varied as desired (provided the assembled multilayer laminated structure retains the desired degree of flexibility and strength), but typically will be within the range of from about 5 to about 50 microns.

The film layer that will be on the outside of a package or other container fabricated from a multilayer laminated structure in accordance with the present invention need not be entirely clear or transparent. For example, portions of the exterior film layer may be opaque or imprinted with a design or pattern or contain a foil stamp, hologram, or the like. Also, the clear film layer may be tinted or colored, so that the developed image formed in the imaging layer underneath is still visible but is altered in appearance by the tinted clear film layer.

In certain embodiments, the multilayer laminated structures of the present invention comprise one or more opaque layers. An opaque layer may be helpful in improving the quality of the image produced by image-wise exposing and developing the imaging layer. An opaque layer, however, should not be placed between the imaging layer and the exterior side of the multilayer laminated structure (the side that is on the outside of a pouch or other container formed from the multilayer laminated structure) since the imaged layer produced would thereby be obscured from view.

Many different materials could be used as an opaque layer, but in one embodiment the opaque layer is comprised of a thermoplastic film containing an opacifying agent. The thermoplastic in the film may be any of the polymers described herein in connection with the clear film layers and barrier film layers of the multilayer laminated structure. For example, the opaque thermoplastic film may be comprised of a polyolefin or polyester. The opacifying agent may be, for example, an inert, finely divided, light-reflecting material which exhibits a white opaque background, although colored or black opacifying agents could also be used. Titanium dioxide, magnesium carbonate, and barium sulfate are examples of suitable white opacifying agents. The opaque layer could also be created using paper or paper lined or coated with a thermoplastic such as a polyolefin or polyester. The-thickness of the opaque layer is not particularly critical, but typically may be from about 10 to about 250 microns. The opaque layer may also be selected so as to function as a barrier layer (i.e., the barrier layer may be opaque).

The opaque layer may also be a reflective layer (i.e., a layer which reflects visible light or other forms of radiation). For example, the reflective layer may be a metallic foil (e.g., aluminum foil) or a metallized polymer film. In one embodiment of the invention, the imaging layer is positioned adjacent to a reflective layer (optionally, with a clear adhesive layer inbetween the imaging layer and the reflective layer). Such an arrangement can result in faster recording of a latent image in the imaging layer as a result of the actinic radiation used to image-wise expose the imaging layer being reflected from the, reflective layer. Suitable reflective layers are described, for example, in U.S. Pat. No. 4,910,117 (incorporated herein by reference in its entirety). The reflective layer may also function as a barrier layer and/or a sealable layer.

In one embodiment of the invention, the surface of the multilayer laminated structure opposite that of the sealable layer (e.g., the surface that will be on the outside of a package formed from the multilayer laminated structure) will be a protective coating comprising a cured film of a resin (for example, a water-soluble or water-dispersible resin). This protective coating may, for example, be placed on top of the imaging layer and is preferably selected to provide scratch resistance, gloss, durability and/or water resistance to the outside of the package fabricated from the multilayer laminated structure. The protective coating can be applied directly to the imaging layer as a solution or dispersion (in water, for example) which is dried or cured. The solution or dispersion may comprise one or more thermosettable (crosslinkable) resins and one or more crosslinking agents capable of inducing crosslinking of the resin(s). Thermoplastic resins could alternatively be used, although where the multilayer laminated structure is intended for use in the manufacture of retortable food pouches it is generally highly preferred to select a formulation that when dried or cured provides a protective coating that is sufficiently heat resistant to withstand the relatively high temperatures during the retorting process. The resin(s) preferably are film-forming resins and ordinarily are preferably selected to provide an essentially clear or transparent protective coating once dried or cured. For example, the solution or dispersion applied to form the protective coating may comprise an acrylic latex and a polyaldehyde crosslinking agent such as glyoxal, as described in U.S. Pat. No. 6,635,399, incorporated herein by reference in its entirety. The protective coating formulations described in U.S. Pat. No. 6,890,880 (incorporated herein by reference in its entirety) could also be utilized. Other components may additionally be present in the protective coating, such as surfactants, stabilizers (e.g., antioxidants, UV absorbing compounds), pigments, matting agents, fillers, insolubilizers and the like. The thickness of the protective coating is not believed to be particularly critical, but may for instance be from about 2 to about 20 microns.

In addition to the different types of layers described hereinabove, the multilayer laminated structures of the present invention may contain one or more primer layers that function so as to enhance the adhesion of two layers to each other. That is, the adhesion of two adjacent layers laminated together is improved by placing a primer layer therebetween. The choice of primer will depend upon the nature of each of the two adjacent layers, but the worker skilled in the art can readily make such selection. For example, primer layers (also sometimes referred to as “subbing layers”) have been described in the patent literature associated with the laminate structures containing imaging layers that are also capable of being utilized in the present invention. See, for instance, WO 00/72091 and U.S. Pat. Nos. 5,783,353, 5,916,727, 6,030,740, 6,080,520, 6,387,585, 6,649,318, and 6,740,465, each of which is incorporated herein by reference in its entirety.

The following examples illustrate how the multilayer laminated structures of the present invention may be assembled where the imaging layer comprises radiation-hardenable microcapsules that are image-wise exposed and the latent image thereby created subsequently developed by application of pressure and/or heat. Analogous procedures can be easily adapted and utilized for other imaging systems that are based on other methods of color formation.

A multilayer laminated structure in accordance with the present invention can, for example, be assembled in the following ways. An imaging (exposure) station which is either separate from or integrated with a laminator may be utilized.

In one illustrative assembly method, a clear film is coated with an imaging layer containing radiation-sensitive microcapsules (encapsulating dye precursors) and at least one developer compound. The resulting web is then image-wise exposed to record a latent image, followed by lamination to either the remaining layers or components of the multilayer laminated structure or to a barrier layer followed by additional lamination steps to attach the sealable layer. A nip roller or set of nip rollers used for lamination of the multiple layers may be used to apply sufficient pressure to crush or otherwise rupture the unhardened and partially hardened microcapsules, thus allowing the dye precursors to react with the developer compound turning the dye precursors into their colored forms. A web or sheet of the multilayer laminated structure (or precursor thereto containing an imaging layer) may also be passed between a pair of nip rollers in pressure contact with each other and capable of applying sufficient pressure to the web or sheet to selectively rupture the unhardened and partially hardened microcapsules containing dye precursors. Some heating of the imaging layer can be additionally used to accelerate the color density development. This heating step could be coordinated so that it is carried out at the same time as other processing steps wherein the multilayer laminated structure is subjected to heating, such as, for example, retorting of a food pouch fabricated from the multilayer laminated structure or curing of an adhesive layer in the multilayer laminated structure. The multilayer laminated structure thus created contains full color images (i.e., the imaging layer has been converted into an imaged layer) and is ready to be further converted into pouches.

In another exemplary assembly method, a barrier film is coated with an imaging layer. A clear protective overcoat is then applied onto the imaging layer. The web thereby obtained is then image-wise exposed and laminated against a sealable layer using an adhesive. The sealable layer may be selected so as to function additionally as a barrier layer. The pressure of the nip roller(s) used in this lamination step is (are) selected to be effective to crush or otherwise selectively rupture the microcapsules similar to the aforementioned method. The structure created by this method thus could contain only one film layer and use a protective coating over the imaged layer instead of lamination, thus generating some cost savings by avoiding the use of expensive films.

If an imaging layer containing adhesive is used (i.e., where the imaging layer is formulated to have adhesive properties, particularly sufficient bond strength once cured or set to prevent delamination of the layers of the assembled multilayer laminated structure), the multilayer laminated structure can be assembled as explained below using an imaging station that is integrated into the laminator.

The imaging layer may be based on a two component adhesive (i.e., an adhesive containing a hardener or curing agent in one component which is capable of reacting with one or more reactive substances in a second component at ambient processing temperatures). The radiation-sensitive microcapsules can be dispersed in either or both of the two components of such an adhesive; the preferred embodiment will depend on the stability of the formulation and adhesive performance. The developer compound can be dispersed either in the same part of the adhesive as the microcapsules or in a different part. The preferred embodiment will be governed by the stability of the adhesive formulation selected as well as the performance of the adhesive. The two components may be mixed and applied onto a clear film using conventional two component adhesive dispensing equipment. The resulting web can then be image-wise exposed and laminated against a barrier layer. The pressure from the nip roller(s) that is applied during lamination is selected to be sufficient to crush or rupture the microcapsules and produce colored images. Heat (e.g., heating the multilayer laminated structure at about 35 to about 70 degrees C.) can be applied to accelerate the color development and cure of the adhesive.

In another embodiment, the adhesive system employed may be a one component adhesive. For example, an imaging layer comprised of radiation-sensitive microcapsules (encapsulating dye precursors), developer compound(s), and adhesive ingredients may be applied onto a clear film followed by the image-wise exposure of the imaging layer on the laminator. The resulting laminate structure may then be pressed against the barrier layer using a nip roller or set of nip rollers, which would crush the unhardened microcapsules present in the imaging layer. The color image would thus be created within the laminated structure.

The different layers described above may be assembled into a multilayer laminated structure in accordance with the present invention using a number of different sequences (that is, the order in which the different layers appear in the structure relative to each other may be varied as may be desired to achieve a desired set of performance characteristics). If the multilayer laminated structure is intended to be utilized as a sheet of flexible laminate packaging material in the manufacture of a pouch for containing foodstuffs, however, the following specific structures are among the preferred embodiments of the invention. In each case, the first named layer is the layer that is to be on the exterior of the pouch or other container while the last named layer is the layer that is to be on the interior of the pouch or other container (i.e., in contact with the foodstuff).
1. Clear Film Layer//Imaging Layer//Adhesive Layer//Barrier Layer//Adhesive Layer//Sealable Layer
2. Clear Protective Coating Layer//Imaging Layer//Primer Layer//Barrier Layer//Adhesive Layer//Sealable Layer
3. Clear Film Layer//Combined Imaging Layer & Adhesive Layer//Barrier Layer//Adhesive Layer//Sealable Layer
4. Clear Film Layer//Primer Layer//Imaging Layer//Adhesive Layer//Barrier Layer//Adhesive Layer//Sealable Layer
5. Clear Barrier Film//Imaging Layer//Adhesive Layer//Heat Sealable Layer
6. Clear Barrier Film//Imaging Layer//Adhesive Layer//Opaque Film//Adhesive Layer//Sealable Layer
7. Clear Barrier Film//Imaging Layer//Adhesive Layer//Barrier Layer//Adhesive Layer//Sealable Layer
8. Clear Film Layer//Primer Layer//Combined Imaging Layer & Adhesive Layer//Barrier Film Layer//Adhesive//Sealable Layer
9. Clear Barrier Film//Combined Imaging Layer & Adhesive Layer//Sealable Layer
10. Clear Barrier Film//Combined Imaging Layer & Adhesive Layer//Opaque Film//Adhesive Layer//Sealable Layer
11. Clear Barrier Film//Combined Imaging Layer & Adhesive Layer//Barrier Film//Adhesive Layer//Sealable Layer
12. Clear Film or Protective Coating LayerII Combined Imaging Layer & Adhesive LayerII Combined Barrier & Sealable Layer

Thus, in one embodiment the multilayer laminated structure comprises, in consecutive order relative to each other in the structure, a) a clear film, b) an imaging layer capable of recording a latent image that can be activated to form an image (such as by operation of an externally applied agent upon the imaging layer) or an imaged layer containing an image formed by activation of a latent image (such as by operation of an externally applied agent), c) a first adhesive layer, d) a barrier film or foil, e) a second adhesive layer, and e) a sealable layer (e.g., a heat sealable layer). In a related embodiment, layers b) and c) are combined in a single layer (wherein the combined single layer functions as an adhesive and also provides a means of recording a latent image). In another related embodiment, the multilayer laminated structure additionally includes a primer layer (preferably, a clear primer layer) between the clear film and the imaging layer.

In another embodiment, the multilayer laminated structure comprises, in consecutive order relative to each other in the structure, a) a clear protective coating layer, b) an imaging layer capable of recording a latent image that can be activated to form an image (such as by operation of an externally applied agent upon the imaging layer) or an imaged layer containing an image formed by activation of a latent image (such as by operation of an externally applied agent), c) a primer layer, d) a barrier film or foil, e) an adhesive layer, and f) a sealable layer (e.g., a heat sealable layer).

In another embodiment, the multilayer laminated structure comprises, in consecutive order relative to each other in the structure, a) a clear film, b) an imaging adhesive layer capable of recording a latent image that can be activated to form an image (such as by operation of an externally applied agent upon the imaging layer) or an imaged layer containing an image formed by activation of a latent image (such as by operation of an externally applied agent), c) a barrier film or foil, d) an adhesive layer, and e) a sealable layer (e.g., a heat sealable layer).

In another embodiment, the multilayer laminated structure comprises, in consecutive order relative to each other in the structure, a) a clear barrier film, b) an imaging layer capable of recording a latent image that can be activated to form an image (such as by operation of an externally applied agent upon the imaging layer) or an imaged layer containing an image formed by activation of a latent image (such as by operation of an externally applied agent), c) a first adhesive layer, d) a barrier film, foil or-opaque film, e) a second adhesive layer, and f) a sealable layer (e.g., a heat sealable layer).

In another embodiment, the multilayer laminated structure comprises, in consecutive order relative to each other in the structure, a) a clear barrier film, b) an imaging layer capable of recording a latent image that can be activated to form an image (such as by operation of an externally applied agent upon the imaging layer) or an imaged layer containing an image formed by activation of a latent image (such as by operation of an externally applied agent), c) an adhesive layer, and d) a sealable layer (e.g., a heat sealable layer).

In another embodiment, the multilayer laminated structure comprises, in consecutive order relative to each other in the structure, a) a clear film, b) an imaging layer capable of recording a latent image that can be activated to form an image (such as by operation of an externally applied agent upon the imaging layer) or an imaged layer containing an image formed by activation of a latent image (such as by operation of an externally applied agent), c) an adhesive layer, and d) a sealable barrier layer (e.g., a heat sealable barrier layer).

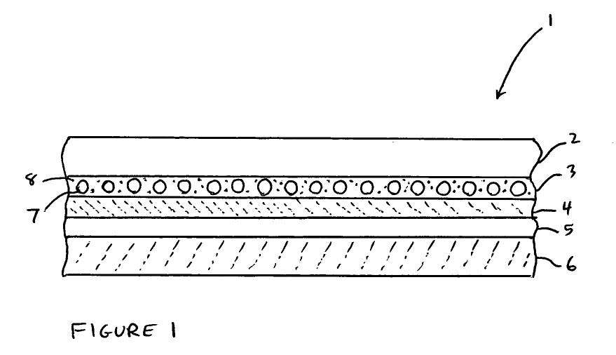

One embodiment of the multilayer laminated structure of the present invention is illustrated in FIG. 1. This structure (1) comprises in order: a clear film (alternatively, a clear protective coating) (2), an imaging/adhesive layer (3) comprising radiation-sensitive microcapsules (7) and a developer material (8) in an adhesive matrix, a barrier layer (4), a second adhesive layer (5), and a sealable layer (6). By image-wise exposing this structure to actinic radiation, the microcapsules are differentially hardened in the exposed areas and a latent image is recorded. Subjecting the exposed structure to pressure (using nip rollers, for example) causes rupturing of the unhardened microcapsules, thereby allowing the color precursors originally within the microcapsules to come into contact with the developer material and form color (i.e., image development).

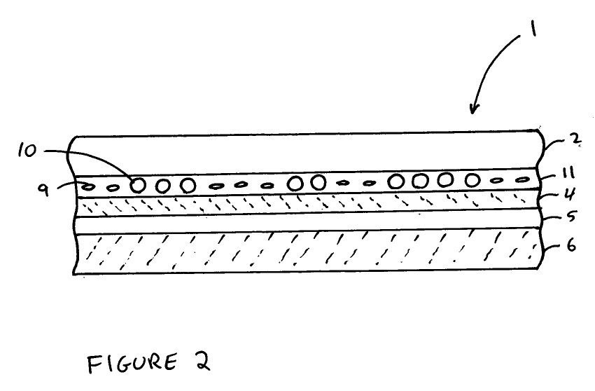

FIG. 2 illustrates the multilayer laminated structure (1) of FIG. 1 after selective exposure and rupture of the microcapsules (7). The imaged layer (11) contains both ruptured microcapsules (9) and unruptured microcapsules (10). Areas of the imaged layer containing ruptured microcapsules develop color and thus an image as a result of reaction between the color precursors and the developer material.

Of course, as explained elsewhere in this application, the imaging layer may be exposed and developed before assembly of the multilayer laminated structure is completed. Yet another alternative is to expose the imaging layer to actinic radiation before the multilayer laminated structure is completely assembled, but to carry out image development simultaneously with one of the lamination steps used to assemble the multilayer laminated structure (e.g., the pressure applied to laminate different layers together may also be used to rupture the microcapsules in the imaging layer to develop the latent image recorded therein). In still other embodiments, the imaging layer is only exposed to actinic radiation and developed (using pressure, for example) after the multilayer laminated structure is completely assembled or even after the multilayer laminated structure is formed into a flexible laminate packaging material such as a pouch or other container.

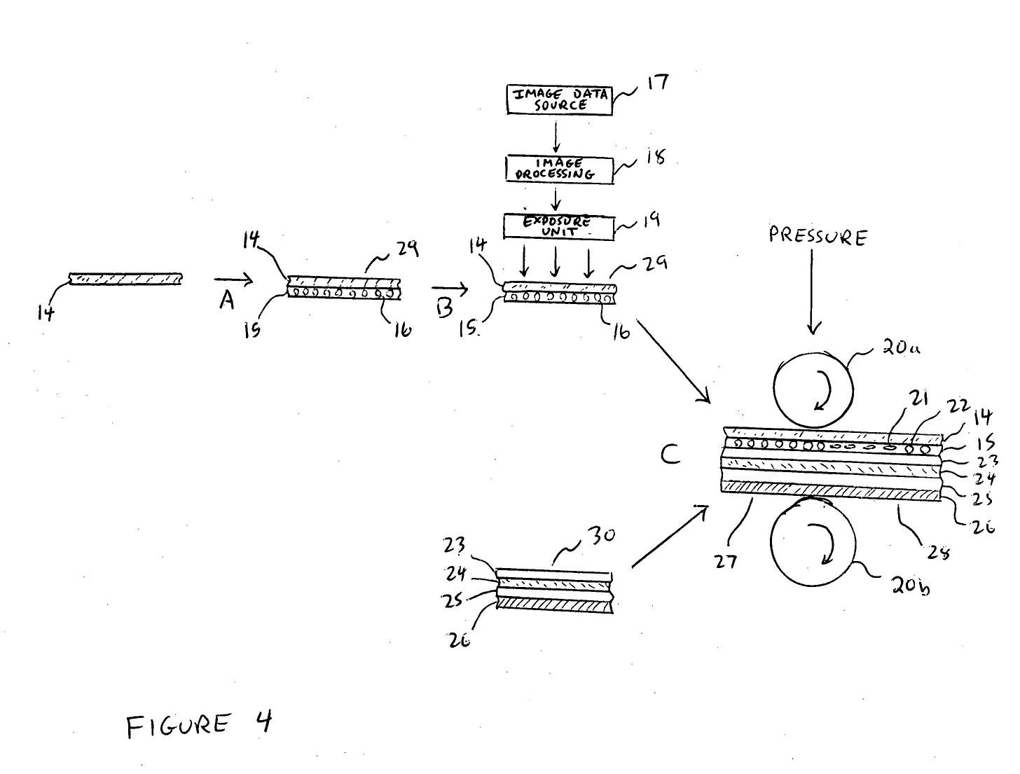

FIG. 4 illustrates in schematic form one way in which a multilayer laminated structure in accordance with the present invention can be assembled. In Step A, a clear film (14) is coated with an imaging layer (15), which may comprise radiation-hardenable microcapsules (16) encapsulating one or more color precursors as well as color developers contained in the imaging layer matrix (which may be adhesive in character) outside the microcapsules. In Step B, the laminate (29) comprised of clear film (14) and imaging layer (15) is image-wise exposed to actinic radiation using an arrangement of an image data processing unit (which can, for example, be comprised of an image date source (17) and an image processing unit (18) such as a PC) and an exposure unit (19) so that a portion of the microcapsules (16) are selectively hardened by actinic radiation from the exposure unit (19) to record a latent image in the imaging layer (15). A latent image recording system of the type described in U.S. Pat. No. 4,941,038 (incorporated herein by reference in its entirety) may be utilized, for example. Although FIG. 4 shows the imaging layer being image-wise exposed to actinic radiation from the clear film side of laminate (29), it may be preferable for the imaging layer to be exposed directly to the radiation (i.e., with the imaging layer-side of laminate (29) facing the exposure unit (19). This is particularly true where the imaging layer is coated onto a film other than a clear film, such as a colored, opaque or pigmented film or a film containing or coated with radiation absorbers or preprinted patterns or images, foil stamps, holograms, or other special effects. In Step C, the image-wise exposed laminate (29) is brought together with a second laminate (30) comprised of adhesive layer (23), first adhesive layer (24), barrier layer (25), and sealable layer (26). The image-wise exposed laminate (29) and second laminate (30) are pressed together using a pair of nip rollers (20a) and (20b) to form the multilayer laminated structure. The pressure applied by the nip rollers (20a) and (20b) is sufficient to cause the image-wise exposed laminate (29) and second, laminate (30) to bond together by means of the first adhesive layer (23) and to cause the non-hardened microcapsules (21) in the imaging layer to rupture, allowing the color precursor(s) within the microcapsules to react with the developer compound(s) in the matrix of the imaging layer. The latent image in the imaging layer is developed as colors are formed as a result of such reactions. The microcapsules (22) fully hardened by the actinic radiation remain intact. Heat can also be applied to the multilayer laminated structure during or after Step C to further accelerate image development and/or adhesive bond strength. The multilayer laminated structure being processed in this manner thus can be considered to be divided into an undeveloped zone (27) and a developed zone (28).

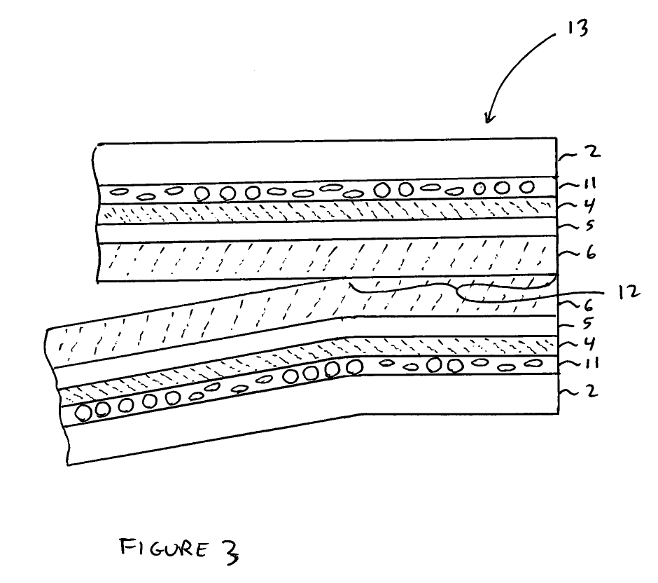

FIG. 3 illustrates a portion of a sealed packaging material (13) constructed from a multilayer laminated structure in accordance with the present invention and as shown in FIG. 2. Two portions of the multilayer laminated structure (1) have been positioned next to each other, with the sealable layers (6) facing each other. These two portions could be in the form of two separate sheets or a single sheet that is folded over on itself. Heat is applied (using a heated bar, for example) and the two portions are pressed together in region (12), forming a heat seal between the two portions in region (12) wherein the sealable layers (6) are fused (welded) to each other. Alternatively, the seal can be formed by placing a layer of adhesive between the sealable layers (6) in region (12).

The multilayer laminated structures of the present invention are especially suitable for the fabrication of packages, such as retortable pouches for the packaging of food, as the imaging layer provides the capability of creating full color, high quality graphics on such packaging. For example, a pillow pouch may be formed from two sheets of the multilayer laminated structure that are arranged so that the sides having the sealable layer thereon are positioned facing each other and then joined and sealed together around their respective edges (by heat sealing or by use of an adhesive, for example). The heat sealing can be performed by any one or more of a wide variety of methods, such as the use of heated bars, hot wires, hot air, infrared radiation, ultrasonic radiation, radio or high frequency radiation, heating knives, impulse sealers, ultrasonic sealers, induction heating sealers, etc., as appropriate. Alternatively, one of the two sheets may be an alternative flexible laminate (i.e., a laminate other than a multilayer laminated structure in accordance with the present invention) provided it has the capability of being similarly sealed to the other sheet. A storage space is thereby defined by the non-sealed area between the two sheets and within the sealed edges. The storage space contains the contents of the pouch (e.g., a foodstuff) and is ultimately sealed off from the surrounding environment. The sealed package may thereafter be subjected to a retort treatment, e.g., heating to a temperature of at least about 120 degrees for a time effective to pasteurize the contents of the pouch (e.g., about 20 to about 90 minutes). The multilayer laminated structure sheets can be formed in any suitable shape that may be desired for containing the foodstuff, such as, for example, a rectangular or square or other polygonal or non-polygonal shape.

A single sheet of the multilayer laminated structure in accordance with the invention could alternatively be used. This sheet can be folded upon itself (with the heat sealable layer on the inside) to form the two sides of the pouch. Once the desired product (e.g., a foodstuff) is placed within the folded-over sides, the remaining edges of the sheet may be heat sealed together so as to enclose the contents.

The present invention thus provides a method of packaging a foodstuff, said method comprising
a) forming a sheet comprising a multilayer laminated structure comprising:
   a clear film or protective coating outer layer;
   an imaged layer obtained by activating a latent image recorded in an imaging layer using an externally applied agent;
   at least one barrier layer;
   at least one adhesive layer; and
   a sealable inner layer;
into a pouch including a storage space formed by said at least one sheet, either alone or in cooperation with at least one additional sheet containing a sealable layer, and at least a portion of the sealable inner layer is sealed to itself or a second sealable layer;
b) placing said foodstuff into said storage space; and
c) sealing said pouch.

In one embodiment, the sealable inner layer is heat sealable and is sealed to itself or the second sealable layer by heat sealing. Also, it is preferred that the pouch be completely sealed so as to substantially inhibit the ingress of bacteria into the storage space. Preferably, the materials used in the pouch and the sealing method are selected such that the sealed pouch containing the foodstuff is capable of withstanding retorting (e.g., heating at a temperature of at least 100, at least 110, or at least 120 degrees C. for at least 30 minutes without delamination or degradation of the multilayer laminated structure or breakage or release of the seal).

A multilayer laminated structure according to the present invention may also be utilized to manufacture a gusset or stand-up retortable pouch. For example, a gusset pouch may include two sheets of the multilayer sheet (or, alternatively, one sheet of the multilayer laminated structure and a sheet of a different flexible laminate having one side that is capable of being sealed to the multilayer laminated structure). One sheet is folded to form the front and back sheets of the pouch. The sheets are joined and sealed together about their respective edges (by heat sealing, for example) around the sides and top, with seals also formed in the bottom gusset. The area between the three sheets and within the heat seals thereby creates a storage space that is sealed off from the surrounding environment and contains the contents of the pouch such as a foodstuff. The sheets can be any shape suitable or desired for containing a foodstuff, including for example a rectangular or square or other polygonal or non-polygonal shape.

In one embodiment, a pouch machine is fed with two webs of the multilayer laminated structure (or, alternatively, one web of a multilayer laminated structure in accordance with the present invention and one web of a different sealable laminate). A main web is used as the source of a sheet that is folded in half along one side of the pouch to form a front sheet and the back sheet, which are positioned in alignment with and on top of each other. The free edges of the sheets are sealed together along the other side of the pouch. The second web is fed into the side of the machine to form a bottom gusset sheet, which is sealed to the front and back sheets to form an open-topped pouch. After the pouch has been filled with a foodstuff or the like, the top edges of the front and back sheets may sealed together using a suitable sealing method. It will also be apparent that a single sheet of the multilayer laminated structure of the present invention could be utilized to form a gusset or stand-up retortable pouch. For example, the sheet could be folded upon itself to form the three sheets mentioned previously. Typically, the middle of the single sheet would form the desired gusset, and the ends would meet at the top of the pouch. The unconnected side and top edges may then be sealed, at least one of them being sealed only after the foodstuff or other material to be packaged is placed between the folded-over sheet.

The multilayer laminated structures of the present invention may also be used in the manufacture of semirigid or rigid packaging containers (including retortable containers). Such a container may comprise, for example:
a) a container tray having a flange for sealing; and
b) a sheet of a multilayer laminated structure in accordance with the invention;
   wherein the sealable layer of the multilayer laminated structure is sealed to the flange of the container tray (using heat sealing or adhesive sealing, for example).

The multilayer laminated structures of the invention thus can be used as lidding stock in a process for preparing a food package comprising the steps of:
a) filling a flanged plastic tray with a food product;
b) positioning a sheet of the multilayer laminated structure over the filled tray (with the sealable layer facing the flange of the plastic tray); and
c) sealing the sheet of the multilayer laminated structure entirely around the flange of the tray so as to enclose the food package and so as to leave a loose edge or tab of the sheet for opening the food package. When the loose edge or tab is peeled back, the seal between the multilayer laminated structure and the tray cohesively fails.

The sealable layer may be a heat sealable layer and may be comprised of two different films (for example, two different polyolefin films) so that when the above described food package is opened, the interface between the two different films in the sealable layer cohesively fails. One layer remains on the flange of the tray while the other layer is peeled off along with the remainder of the multilayer laminated structure. The sealable layer may, for example, be a co-extruded film. Of course, where the container is intended to be retorted, this type of arrangement must also be capable of surviving retort conditions and other processing of the food package such that the seal between the two layers remains intact during such processing, thereby avoiding any release or contamination of the contents of the food package prior to the time the user wishes to open the food package.

Other approaches known in the art may also be employed to incorporate the multilayer laminated structures of the present invention into pouches, containers, enclosures and the like. That is, a web of the multilayer laminated structure may be substituted for a web of any conventional flexible laminate having a sealable layer on at least one side.

As an example, in most cold seal packaging applications, a cold seal adhesive is applied in a pattern around the perimeter of a sheet of a film laminate. The film laminate sheet is then positioned adjacent to a second sheet of a film laminate also bearing a layer of cold seal adhesive around its perimeter, with the layers of cold seal adhesive being pressed against each other at about room temperature to bond the two sheets together. The multilayer laminated structure of the present invention may be substituted for one or both of the above-mentioned film laminate sheets, with the cold seal adhesive being applied to the sealable layer side of the multilayer laminated structure sheet.

The multilayer laminate structures described herein may also be used in packaging applications where the package contains a substance or object other than a foodstuff and/or where the package is not subjected to retorting.

For instance, the multilayer laminated structures of the present invention may be readily adapted for use in form-fill-seal (FFS) packaging, aseptic packaging, cold seal packaging, resealable/reclosable containers and the like. Products other than foodstuffs that are capable of being packaged or encapsulated using pouches, bags, containers or other enclosures formed from the multilayer laminated structures include, but are not limited to, personal care products (e.g., soap, cosmetics, lotions, shampoos, conditioners, styling gels), electronic/electrical components (e.g., batteries), cleaning products (e.g., hard surface cleaners, wipes), medical products (e.g., drugs, antiseptic products), maintenance products (e.g., oil, lubricant, polishes) and the like.

What is claimed is:

1. A flexible laminate packaging material comprising a first multilayer laminated structure comprising a first sealable layer and a second multilayer laminated structure comprising a second sealable layer, wherein said first sealable layer and said second sealable layer are the same or different, at least portions of the surfaces of the first sealable layer and the second sealable layer are sealed to each other, and at least one of either the first multilayer laminated structure or the second multilayer laminated structure is additionally comprised of a) an imaging layer, said imaging layer being capable of recording a latent image that can be activated to form an image, or b) an imaged layer containing an image formed by activation of a latent image.

2. The flexible laminate packaging material of claim 1, wherein the first sealable layer and the second sealable layer are sealed by heat sealing.

3. The flexible laminate packaging material of claim 1, where the first sealable layer and the second sealable layer are sealed using an adhesive layer.

4. The flexible laminate packaging material of claim 1, wherein said latent image is recorded using actinic radiation and is activated using an externally applied agent selected from the group consisting of heat, pressure, and combinations thereof.

5. The flexible laminate packaging material of claim 1, wherein said imaging layer is comprised of a plurality of microcapsules.

6. The flexible laminate packaging material of claim 1, wherein said imaging layer is comprised of a plurality of microcapsules which are radiation-hardenable or radiation-softenable and which encapsulate at least one dye precursor or at least one color developer.

7. The flexible laminate packaging material of claim 1, wherein said imaging layer is comprised of an adhesive and a plurality of radiation-sensitive microcapsules.

8. The flexible laminate packaging material of claim 1, wherein the first multilayer laminated structure and the second multilayer laminated structure are each additionally comprised of a barrier layer.

9. The flexible laminate packaging material of claim 1, wherein said imaging layer is comprised of at least one color developer and a plurality of radiation-hardenable microcapsules which encapsulate at least one dye precursor.

10. A flexible laminate packaging material comprising a first multilayer laminated structure comprising a first barrier layer, a first adhesive layer, and a first sealable layer and a second multilayer laminated structure comprising a second barrier layer, a second adhesive layer, and a second sealable layer, wherein at least portions of the surfaces of the first sealable layer and the second sealable layer are sealed to each other and wherein at least one of either the first multilayer laminated structure or the second multilayer laminated structure is additionally comprised of a) an imaging layer, said imaging layer being capable of recording a latent image that can be activated to form an image, or b) an imaged layer containing an image formed by activation of a latent image.

11. The flexible laminate packaging material of claim 10 wherein said imaging layer or imaged layer is part of said first adhesive layer or said second adhesive layer.

12. A pouch having at least one sheet comprising a multilayer laminated structure comprising an imaged layer obtained by activating a latent image and a sealable inner layer, wherein the pouch includes a storage space formed by said at least one sheet, either alone or in cooperation with at least one additional sheet containing a sealable layer, and at least a portion of the sealable inner layer is sealed to itself or a second sealable layer.

13. A pouch having at least one sheet comprising a multilayer laminated structure comprising:
a clear film or protective coating outer layer;
an imaged layer obtained by activating a latent image;
at least one barrier layer;
at least one adhesive layer; and
a sealable inner layer;
wherein the pouch includes a storage space formed by said at least one sheet, either alone or in cooperation with at least one additional sheet containing a sealable layer, and at least a portion of the sealable inner layer is sealed to itself or a second sealable layer.

14. A pouch according to claim 13, wherein said sealable inner layer is heat sealable and is comprised of a polyolefin.

15. A pouch according to claim 13, wherein said barrier layer is a metallic foil, a metallized polymeric film, or an inorganic oxide-coated polymeric film.

16. A pouch according to claim 13, wherein said clear film or protective coating outer layer is comprised of a polyester or a polyamide.

17. A pouch according to claim 13, wherein said imaged layer is obtained from an imaging layer comprised of a plurality of microcapsules.

18. A pouch according to claim 13, wherein said imaged layer is obtained from an imaging layer comprised of a plurality of microcapsules which are radiation-hardenable or radiation-softenable and which encapsulate at least one dye precursor or at least one color developer.

19. A pouch according to claim 13, wherein said imaged layer is obtained from an imaging layer comprised of at least one color developer and a plurality of microcapsules which are radiation-hardenable and which encapsulate at least one dye precursor.

20. A pouch according to claim 13, wherein said imaged layer and said adhesive layer are combined in a single layer.

21. A pouch according to claim 13, wherein said latent image has been activated using an externally applied agent.

22. A pouch according to claim 13, wherein said sealable inner layer is sealed to itself or said second sealable layer by heat sealing.

23. A method of packaging a product, said method comprising
a) forming a sheet comprising a multilayer laminated structure comprising a sealable inner layer and an imaged layer obtained by activating a latent image recorded in an imaging layer into a container including a storage space formed by said at least one sheet, either alone or in cooperation with at least one additional sheet containing a sealable layer, wherein at least a portion of the sealable inner layer is sealed to itself or a second sealable layer;
b) placing said product into said storage space; and
c) sealing said container.

24. A method of packaging a product, said method comprising
a) placing said product into a storage space of a container having an opening;
b) sealing said opening of said container using a sheet comprising a multilayer laminated structure comprising a sealable layer and an imaged layer obtained by activating a latent image recorded in an imaging layer.
